(19) United States
(12) Patent Application Publication
(10) Pub. No.: US 2018/0010850 A1
(43) Pub. Date: Jan. 11, 2018

(54) GRAIN DRIER

(71) Applicant: LIONHEART INVESTMENTS INC., Calgary (CA)

(72) Inventor: STEVEN R. MOORE, Calgary (CA)

(21) Appl. No.: 15/643,299

(22) Filed: Jul. 6, 2017

Related U.S. Application Data
(60) Provisional application No. 62/359,062, filed on Jul. 6, 2016.

(51) Int. Cl. F26B 3/08; F26B 9/06; F26B 21/12

(52) U.S. Cl. CPC F26B 3/08; F26B 21/12; F26B 9/063; F26B 2200/08; F26B 2200/06

(57) ABSTRACT

This invention in the field of grain drying, along with other particulates, provides an apparatus which dehumidifies air, then heats the air to relative low drying temperatures (95-160 Deg. F.), provides the dehumidified, heated air as process air to a system which uses the airflow as a transport method to fluidize the particulate matter and move the mixed process air and particles through a process column for drying. Once a particle reaches a designed moisture level, its mass will have been reduced, and that effect plus the velocity of the process air in the column will float the dried particle up and out of the column for further handling.

### BACKGROUND OF THE INVENTION

Grain and similar small particulate matter often includes moisture content, and it is desirable to reduce the moisture content of the particulate matter to a particular level. This drying effect on small particulate material is often achieved by exposing the particles to heated flowing air.

To be efficient and productive, particulate driers must evenly dry particles being treated quickly and with minimal handling and energy-efficient heating and blowing of the air used in the treatment.

The particles must not be over-exposed to heat, either in terms of temperature or total heat energy, to avoid damage to the particulate material or undue chemical or other changes brought about by over-exposure to heat (for instance, cooking or scorching of grain).

Handling of the particulate matter should be minimal to avoid physical damage to the material or its outer coating or shell if present. Additionally, mechanical handling equipment should be easy to maintain and clean, and designed to avoid wear and clogging.

Accurate measurement of the particulate matter's reduced moisture content during treatment is desirable in order to have a tailored or designed moisture content as an achievable process goal.

### SUMMARY OF THE INVENTION

This invention provides a drier for drying particulate matter, comprising: a dehumidifier to treat process air; a heater to heat dehumidified air from the dehumidifier; b. a conduit to flow the heated, dehumidified process air from the heater past a particulate injection port in the conduit and to a column within a process unit; the injection port can be valved and manipulated to open or close on a modulated basis to permit more or less or no particulate matter to enter the air flow in the conduit; the particulate matter may be provided from a hopper to the conduit's injection port using gravity feed, pneumatic forces if fluidized, or any other means; the process air transports the particulate in a fluidized flow into and up the column in the process unit, drying the particulate matter; when a particle in the particulate matter loses a target amount of moisture and is thus dried to a desired degree, its reduced mass will permit the process air's flow to drive that particle up and out of the process column, and into the process unit; spent process air will vent from the process unit, and may be recycled to the dehumidifier; dried particles are permitted to fall to the bottom of the process unit and can gather there or be permitted to exit for collection and further handling. There are of course, variants to this apparatus and associated process which will be understood by those skilled in the art of grain drying and handling particulate matter for treatment, so the descriptions in this application are meant to be exemplary and not limited except by the claims.

### DESCRIPTION OF THE DRAWINGS

FIG. 1 shows a stylized mock-up of the invention, not to scale.

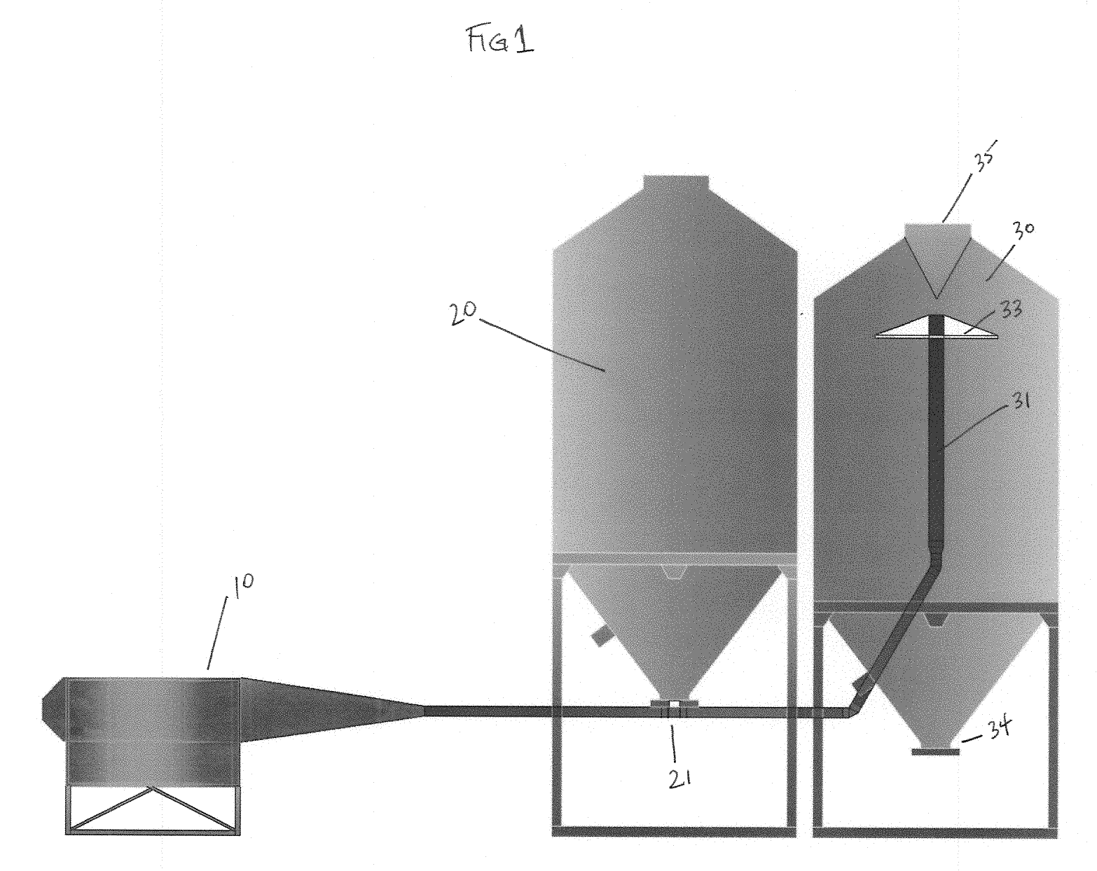

### DETAILED DESCRIPTION

The solution of this invention is essentially:
using relatively conventional dehumidification (for example, by chilling) of air from atmosphere, heating that dehumidified air, optionally using heat exchange means (to capture otherwise waste heat from various processes such as driving the chiller and using its heat to increase air temperature after dehumidification by chilling) 10, the invention provides large volumes of dehumidified and heated air to the process of the invention
particulate matter is introduced in a controlled (gated, metered) fashion to a conduit 21 leading to a process column 31
the particulate matter is exposed to dehumidified and heated air provided at controlled flow velocity and volume, and introduced at controlled air temperature and humidity in the process column 31
during the time period when the particulate matter is exposed to the dried heated airflow in the process column 31, moisture in the particles is drawn/evaporates from the particulate matter and into the airflow so that the moisture content of the particles is reduced at a designed high rate
as moisture departs the particles, the density of each particle is reduced in a measurable proportion to the particle's moisture content—that is, as a particle loses moisture its mass per gross volume and surface area is changed in proportion to the amount of water per volume drawn off into the airflow
as the particles' density changes, the particles' cross-sectional surface area does not change in the same proportion (or at all), consequently the ‘floatation’ characteristics of each particle in the airflow in the process column 31 will change as the density of each particle changes
since the airflow is also used in the process column 31 as a means of pneumatic transport of the particles through the chamber 30, this change in each particle's density/surface area is used to cause the transport of lighter (and thus drier) particles higher into the process column 31 than heavier/higher moisture content particles are transported (until they, too, are dried sufficiently to change ‘buoyancy’)
this moisture-content-based pneumatic transport effect may be used in the invention to differentiate particles which have reached a designated dryness from the bulk of the particles so that as particles of a predictable density (and moisture content) reach a particular height in the airflow in the process column 31; at that point 33, those particles can be removed from the process having attained a predesigned moisture content, by falling to the lower part of the chamber 30 for removal at a port 34
thus, the invention is tailored to achieve a particular moisture content in its operation by tailoring air flow rates, starting air humidity and starting air temperature as well as particle injection rates into the process and removal rates of treated particles at a designated height 33 in the column's 31 upper portion, in order to control dwell time in the heated airflow of each particle, temperature at which particles are exposed, and designed ending moisture content of particles treated

Starting with atmospheric air at ambient temperature and relative humidity, that air is dehumidified to a designated low relative humidity, and is then heated to a designated temperature suitable for drying but not cooking the target feedstock particles of the invention. Typically, these conditions, after dehumidification and heating, will result in air that is at about 96-120 Deg. F. and about 2% relative humidity.

The flow of the dried, heated air can be used as a transport medium and force (fluidized transport) to move wet (or relatively moisture-laden) feedstock particles in a stream mixed with the air from a particle holding means 20 to the process chamber 30 of the invention. Similarly, once the particles reach their target moisture content and are removed from the process column 31, airflow can be used to fluidize the particles to move them to a collection means for further handling, storage, or packaging 34.

In an embodiment, the height of the process column can be 12-16 feet depending upon the desired treatment capacity, airflow velocities, input hopper sizes, and the like; but it has been found that this height of process chamber at relatively high air velocities during treatment permits the particles to have a dwell time in the airflow sufficient to reduce their moisture content in a very short time period, permitting high treatment volumes of flowing fluidized particulate matter through the chamber in a continuous process. Dwell times are typically short, and can be in the realm of milliseconds.

Since fluidized flow is relatively gentle as a handling method for the particulate feedstock being treated, many different types of particles can be treated, for instance: any grain, pulse, rice, corn or corn product, such as wheat, barley, corn, beans, peas, lentils and the like. Similarly, other particles may be suitable for treatment.

These same gentle, low process mechanical forces permit the handling of more delicate particles, crops and process feedstocks. The low temperatures and indirect application of heat, mean that the process equipment and the included particles being treated are not at or near combustion temperatures, so that fewer safety and insurance concerns arise. Drying is relatively uniform due to the intermingling of high speed dry heated air with the feedstock being treated. Clumping is avoided, each particle is separately dried, and temperatures are controlled automatically. Dwell time may be adjusted by adjusting airflow rates (velocity, volumes), temperatures, and injection rates of particles into the airflow in the process chamber, column height or cross-section, for example. These variables may be dynamically adjusted reactive to designed output conditions (temperature and/or humidity of ejected rehumidified air, of dried particles' weight/density/moisture content, or of other process parameters). The process apparatus provides a single pass, continuous process, without mechanical handling means (augers, belts, etc.), is compact and lightweight, and relatively quiet in operation. By using heat exchange means to collect heat from the dehumidifier and output process air and using that collected heat in other spots in the apparatus (perhaps to heat the dehumidified air, or to preheat the particles), the apparatus can be made energy-efficient; similarly, insulation means can reduce heat losses at various parts of the device (around the process chamber, for example).

Pneumatic, fluidized transport reduces mechanical components required for particle handling. This reduces cost, maintenance, jamming and production interruptions, and reduces impacts on the treated particles.

As noted, the functioning of the system can be modulated and controlled automatically to increase and enhance production efficiencies, energy and cost savings. The variables to be controlled and measured can be controlled and measured using simple electronic sensors, variable power supplies to different components of equipment, adjustment of components, and simple computing to automate the processes and systems. Computing resources can be controlled, watched, and configured as required, remotely (if the system is connected to a communications network such as the internet), and its operation and efficiencies can be monitored. Preventive maintenance can be scheduled based upon use and any diagnostics embedded in the apparatus, and this can be done remotely.

When grain is introduced into the medium of dry warm air, the grain starts releasing its moisture within milliseconds. As grain loses moisture, the mass of the grain decreases, which enables the grain to be conveyed to the drying chamber. The percentage of moisture content is based on weight of the grain not time or energy as the process is really quick, in realm of milliseconds per bushel. Therefore the difference between 40% moisture removal and 5% moisture removal is negligible.

All particulate dryers work on the principal of moisture migration. The greater the difference between dew point and wet bulb temperature of the particles, the faster the moisture migrates. In traditional grain dryers grain has to overcome the saturation of the heated air due to high moisture in the air, which has been treated by, for example, capturing exhaust air of a propane flame in air flow, introducing heat as well as the products of combustion (Natural Gas 11.87 Gallons/1MBTU). Therefore the grain has to be taken above water's boiling point to dry. Thus we have time and BTU drying charts in the prior art.

The Phoenix AgriDryer Chart#1 (see Chart #1) reduces the dew point to 33°. As we increase the air medium temperature to 120° F. the dew point differential becomes 57° F. wet bulb. We know according to Holman and Page (1948), reported by Hukill (1974), the moisture migration rate is (retention) at 120° F. and the dew point differential of 1° wb is 0.322 milliseconds. With a 57° wb differential the moisture migration rate decreases to 0.094 milliseconds per pound of dry air.

$$\frac{M t - Me}{Mo - Me} = {E}^{- {Kt}^{n }}$$

According to prior art documents in the literature, (The use of fans in Pneumatic Conveyance), Martin Rhodes (2001) Jacob Fruchtbaum (1988), grains at 50 lbs/ft³ can be conveyed at a velocity of 5000 ft/min. Corn can be conveyed at a velocity of 5600 ft/min by airflow.

We know that to calculate velocity:

$$V = \frac{576 ( CFM )}{π ( {Diameter}^{2} )}$$

With a CFM of 1500, and a diameter of 7 inches, we can calculate the velocity out to 5,612 ft/min, therefore grain can be conveyed using a fan capable of 1500 CFM.

According to the International Journal of Agriculture and Biology (2006), terminal velocities decrease as moisture content decreases. Therefore conveyance of wet grain is irrelevant. Conveyed velocity must be attuned to desired moisture content, if using pneumatic conveyance calculated at desired moisture content.

We know that dry air has a mass of 0.07496 lbs./cu ft. Therefore at 1500 cfm, we have an air mass flow rate of 112.44 lbs./min. We know the qualities of air at 120° F. dry, is capable of absorbing 3.738 gallons of water per pound of dry air (100% saturation). Therefore the amount of moisture that the conditioned air can absorb is 420 gal/min.

We know that the heaviest grain is 60 lbs per bushel (lbs/bu). For 1500 bu/hr we are conveying 25 bu/min. We also know that there are 8.33 lbs/gallon of water in the mix. Therefore at 10% moisture content only 150 lbs of water a minute must be removed to achieve this flow capacity in a fluidized flow.

$$\frac{1500 bu \text{/} hr}{60 hr \text{/} min} \times ( 60 lb \text{/} bu ) \times 0.1 ( 8.33 gal \text{/} lb ) = 18 gal of {H}^{2} O \text{/} min$$

Therefore we can conclude using this math, that 1500 cfm is more than capable of removing 10% moisture content and more. Also an air blowing fan from Delhi™ in the design of the Phoenix AgriDryer, with a 7.5 HP motor is very capable of providing the necessary 1500 cfm.

Heating Coil

A 5 pass coil at 190° F. is considered adequate. Outside air temperature is assumed for this purpose to be at 32° F. Total temperature drop across coil is 20° F., Total BTU/HR required 244,000.

Dehumidification Coil

A 4 pass coil in an embodiment will maintain a 26° F. temperature and will require 36,000 to 42,000 btu/hr to maintain this temperature. This is controlled by a modulated expansion valve and a variable frequency drive compressor. This will produce a relative humidity of 0.5% to 0.7%, and a dew point of 32° F.

Fan

The fan is a reverse incline fan able to withstand high static pressure; also utilizing a variable frequency drive, will produce between 1000 cfm and 1700 cfm.

Pneumatic Conveyance

Each grain or seed has a terminal velocity according to Saltation tables, where the product is picked up and floated. As we lower the grain mass, the velocity of the air will lift the grain. In this way, by adjusting the velocity of the equilibrium or the height or cross section of the column, the moisture content of the grain controls when it is ejected. By changing the velocity or the column or any other equilibrium-related variable the type of grain or oil seed and targeted moisture content is selected.

Equilibrium Properties

Designed for 32° F. ambient air, in Alberta this has a relative humidity of 50% (each province, state and country has its own relative humidity, generally speaking). ASHRAE would be consulted for proper relative humidity decreased to 30%, the dew point is 82%, so we may extract humidity down to 0.5% or 0.7% at 170° F. which is 190° F. less 20° F. differential across the coil. This will lower the dew point of the grain to almost 0° F. The latent heat value is now lowered from 3,870 BTU/LB/hr to 270 BTU/LB/hr. The total amount of energy required to dry from 24% is in the range of 18,068 BTU/FT³/hr compared to 224,532 BTU/ft³/hr using conventional means.

Properties of Grain

All grains increase in weight proportionate to moisture content (M.C.). Once grain exceeds 104° F. the quality of the grain decreases substantially. If grain is left in a bin at 104° F. and higher, the grain will lose its germination quality by as much as 35%. By drying the grain at 96.6° F., it gives us the ability to overshoot this target temperature a couple of degrees without damage to the grain. Pneumatic Conveyance uses mass instead of density to calculate terminal velocity. Therefore there is a difference in density in grain that is 24% M.C. compared with grain that is related to dried at 12% M.C.; the difference in mass is constant, so the mass calculated can be the mass of the grain with zero moisture and as we add moisture to the equation, it is calculated at the mass of the water. Therefore, as we calculate the specific heat of grain, we need also to calculate the specific heat of water which has a specific heat of 1 BTU/Ib/hr and grain at which has a specific heat value of 0.05 BTU/Ib/hr.

Oil Seeds

As established with grains, we calculate terminal velocity with mass not density. Again, using pneumatic conveyance which bases terminal velocity on mass instead of density, as the mass decreases, terminal velocity decreases.

Dryer Operation

The dryer uses a three tier process, each component dries within itself.

1. Heating to 96.6° F.

2. Pneumatic Conveyance

3. Dry Air

The combination of all three make the Phoenix Dryer a very efficient drying process with current technology and gives operational control over end-point moisture content. The drying process can be adapted to any grain or seed at any moisture content with a simple program change.

Each granule enters into the flowing dehumidified heated airflow medium, as grain temperature increases the temperature transfers energy to the grain, the grain will sweat to equalize moisture between the grain and the atmosphere. This process takes seconds or less. As each grain equalizes with the equilibrium, the equilibrium will increase humidity, but the granule will lighten and the saltation effects carry the grain up the drying column and out into the bin 30. Once it reaches the bin, the velocity drops and the granule and grain is poured out into the holding bin (not shown). On the top of the vessel 30 there is a screen 35 which will allow high humidity air from the drying process escape to the atmosphere.

As the now humid air leaves the dryer, the humid air will want to condense at the top of the outside of the bin. This moisture can be collected and sent to a cistern to be stored.

Cooling Period

Once the grain has left the drying chamber the grain will settle in the bin 30. At this time the grain will begin its cooling process which will happen naturally from the stack effect of the humid air leaving the bin through the top 35, thus creating a cooling effect of the entire bin.

Extraction

As the grain settles in the holding bin 35, the grain can be extracted from the bin at the bottom of the bin through a tube 34. The grain can also be extracted from this holding bin at any time. Because the grain never exceeds 96.6° F., the integrity of the grain is never fragile, and can therefore be pulled out of the bin 30.

1. A drier for drying particulate matter, comprising:
a. A dehumidifier to treat process air
b. A heater to heat dehumidified air from the dehumidifier
c. A conduit to flow the heated, dehumidified process air from the heater to past a particulate injection port in the conduit and to a column within a process unit
d. The injection port can be manipulated to open or close on a graduated basis to permit more or less or no particulate matter to enter the conduit
e. Particulate matter may be provided from a hopper to the conduit's injection port using gravity feed, pneumatic forces if fluidized, or any other means
f. The process air transports the particulate in a fluidized flow into and up the column in the process unit, drying the particulate matter
g. When a particle in the particulate matter loses a target amount of water and is thus dried to a desired degree, its lowered mass will permit the process air's flow to drive that particle up and out of the process column, and into the process unit
h. Spent process air will vent from the process unit
i. Dried particles will be permitted to fall to the bottom of the process unit and can gather there or be permitted to exit for collection and further handling handling.

2. The drier of claim 1, where the relative humidity of the process air after the heating step in the heater b is 0-2%.

3. The drier of claim 1 where the temperature of the process air after the heating step in heater b is 95-160° F.

4. The drier of claim 1 where the process column is between 12-18 feet in length.

5. The drier of claim 1 where some vented spent process air from the process unit is recycled into the dehumidifier.

6. The drier of claim 1 when air flow is 4600-5600 CFM.

7. The drier of claim 1 where some vented spent process air may be directed to a heat exchange unit to assist in the heating step performed by heater b.

8. A process for drying particulate matter comprising the steps of:
a. Obtaining air
b. Dehumidifying the air
c. Heating the dehumidified air
d. Introducing the particulate matter to the dehumidified and heated air, and flowing the particulate matter and the air into a process column
e. Modulating particulate dwell time in exposure to the air in the process column to obtain a targeted drying effect on the particulate so that the particulate reaches a desired moisture content
f. Modulating process conditions, chiefly air flow rates and particle introduction rates, so that particles reaching a desired moisture content will have a reduced mass from the lesser treated particles but similar surface area exposure to airflow in the column, sufficient that the airflow interacts with the reduced mass to force particles of targeted dryness out of the process column.

9. Controlling the process by modifying conditions of the airflow which affect the equilibrium point at which the particulate's mass is reduced and the particles are ejected at a corresponding target moisture content.
